(19) United States
(12) Patent Application Publication
(10) Pub. No.: US 2026/0203536 A1
(43) Pub. Date: Jul. 16, 2026

(54) OPTOELECTRONIC SENSOR, USE AND METHOD FOR DETECTING AND/OR READING BARCODES

(71) Applicant: SICK AG, Waldkirch (DE)

(72) Inventors: Frank SCHÜTZ, Rheinhausen (DE); Sebastian HÖRNER, Staufen (DE)

(21) Appl. No.: 19/449,047

(22) Filed: Jan. 14, 2026

(30) Foreign Application Priority Data
Jan. 15, 2025 (DE) 102025101366.7

(51) Int. Cl. G06K 7/14

(52) U.S. Cl. CPC G06K 7/1413

(57) ABSTRACT

The invention relates to an optoelectronic sensor for detecting and/or reading barcodes, said optoelectronic sensor comprising a pixel array that is configured to receive light transmitted from a field of view as reception light and to obtain reception data about a field of view in so doing; and a processing unit that is configured to use only obtained reception data about a reading zone in the field of view, wherein the reception data about the reading zone are based on reception light received by means of a partial zone of the pixel array.

The invention relates to an optoelectronic sensor, to a use of an optoelectronic sensor, and to a method for detecting and/or reading barcodes.

Laser-based code reading devices are known for detecting and/or reading barcodes. In order to detect and/or read barcodes arranged at objects such as pallets, and in particular barcodes arranged above one another, known laser-based code reading devices often use oscillating mirrors to extend the reading zone, in particular vertically. Such laser-based code reading devices having oscillating mirrors often comprise complicated mechanics and moving parts such as actuators, which increases the costs and/or the error susceptibility.

It is the underlying object of the invention to make the detection and/or reading of barcodes more efficient, in particular more cost-effective and/or more fail-safe.

An optoelectronic sensor having the features of claim 1 is provided to satisfy the object.

The optoelectronic sensor according to the invention for detecting and/or reading barcodes comprises a pixel array that is configured to receive light transmitted from a field of view as reception light and to obtain reception data about the field of view in so doing; and a processing unit that is configured to use only obtained reception data about a reading zone in the field of view, wherein the reception data about the reading zone are based on reception light received by means of a partial zone of the pixel array.

In other words, the invention is based on the idea of using pixel-based technology (e.g. so-called matrix imagers) instead of laser-based technology to detect and/or read barcodes. Since only obtained reception data about the reading zone, which are based on reception light received by means of only a partial zone of the pixel array, are used for detecting and/or reading the barcode, the pixel-based optoelectronic sensor can be specifically adapted to the detection and/or reading of barcodes, in particular 1D codes. The reading zone corresponds to a section of the field of view of the optoelectronic sensor. The barcode can be present in the reading zone. The reading zone can be selected by selecting the partial zone of the pixel array for obtaining the reception data.

Oscillating mirrors and in particular moving parts such as actuators do not have to be provided, whereby the optoelectronic sensor according to the invention is less susceptible to wear and also more robust against shock and vibrations. In this way, costs can be saved and/or the failure safety can be improved. The use of the reception data about the field of view restricted to the reading zone or of the pixel array restricted to the partial zone allows computing power and/or data memory to be saved. As a result, a higher detection speed and/or readout speed or sampling rate can also be achieved. This can be advantageous if the object with the barcode to be detected and/or to be read is moved, in particular past the optoelectronic sensor. Overall, the optoelectronic sensor for detecting and/or reading barcodes can thus be improved in terms of its efficiency, in particular in terms of the costs and/or failure safety.

According to one embodiment, the pixel array is configured (i.e. is, for example, controlled in such a way) to activate and/or read only pixels in the partial zone of the pixel array for the receiving of the reception light. The remaining pixels of the pixel array are not read and can be deactivated. The efficiency can be improved in this way. Alternatively, the reception data obtained by means of the remaining pixels can be discarded (e.g. before their processing).

According to one embodiment, the optoelectronic sensor further comprises an illumination unit that is configured to transmit transmission light into the field of view, wherein the pixel array is configured to receive transmission light reflected from the field of view as reception light and to obtain the reception data about the field of view, in particular about the reading zone, in so doing.

According to one embodiment, the illumination unit comprises at least one row and/or column of light sources, in particular LEDs. Preferably, the light sources are arranged at a marginal region of the pixel array and/or around the pixel array. By detecting and/or reading the barcode only based on the reception data about the reading zone or using only a partial zone of the pixel array, the illumination unit can be simpler and can be provided by LEDs, for example.

According to one embodiment, the illumination unit comprises at least two rows, preferably at least three rows, of light sources that are arranged above the pixel array. Alternatively or additionally, the illumination unit comprises at least two rows, preferably at least three rows, of light sources that are arranged below the pixel array. In order to improve an illumination of the field of view or of reading zones in the field of view, in addition to two rows of light sources, which can be standard in conventional pixel-based sensors, even further rows of light sources can be present above and/or below the pixel array. This can in particular be the case if the field of view or reading zones in the field of view are dynamically detected as described herein.

According to one embodiment, the light sources are individually settable in their illumination intensity. Each of the light sources can therefore be controlled such that any desired illumination intensity (as part of the power range of the respective light source) can be set. Thus, the full field of view can, for example, be generously illuminated. Additionally or alternatively, the illumination can be projected and/or focused onto a specific zone, such as the active reading zone. Overall, an optimal illumination can be achieved. Focused can in this respect be understood to mean that an optics is used to bring about a focusing. Alternatively, no optics (and e.g. no lenses) can also be provided for the focusing so that focusing is then in particular to be understood as a differently pronounced illumination.

According to one embodiment, the light sources are controlled such that the transmission light is focused on the reading zone by setting the illumination intensity of the light sources. In particular, the illumination unit can be configured in such a way to control the light sources such that the transmission light is focused on the reading zone by setting the illumination intensity of the light sources. The illumination can thus be concentrated on the reading zone, which can save energy and reduce costs. Furthermore, the use of simpler and more cost-effective light sources and/or simpler and more cost-effective control electronics can be opened up.

According to one embodiment, the light sources are controlled such that the illumination intensity of the light sources increases along the row of light sources. In particular, the illumination unit can be configured to control the light sources such that the illumination intensity of the light sources increases along the row of light sources. If, for example, the barcode is not guided parallel to or frontally in front of the optoelectronic sensor, the light sources can be controlled such that a region of the barcode that is closer is illuminated less strongly than a region of the barcode that is further away.

According to one embodiment, the pixel array comprises columns and/or rows of pixels, wherein the pixel array is configured (or is controlled in such a way) to receive the reception light with a number of rows and/or a number of columns. The number can be specified in advance. The number can be smaller than the total number of all existing rows and/or columns. The number of rows and/or number of columns can be present in a row region or column region or can correspond to a row region or column region on the pixel array. By selecting the (active) row region or column region, the associated detected reading zone can be flexibly adapted for a specific application. For example, the reading zone can be adapted to an expected position and/or orientation (e.g. vertical or horizontal) of the barcode affixed to an object. Furthermore, the number of pixels to be read or the volume of data to be processed and, as a result, the detection speed and/or readout speed can be set.

According to one embodiment, the pixel array is configured (or is controlled in such a way) to receive reception light with a first row region of the pixel array, wherein the first row region comprises a first number of rows, in particular rows disposed directly next to one another, in particular over their entire width, and to subsequently receive reception light with a second row region of the pixel array, wherein the second row region comprises a second number of rows, in particular rows disposed directly adjacent to one another, in particular over their entire width, wherein the second row region is different from the first row region. The first number and the second number can be the same or different from one another. The first number can be 1 or more and, for example, between 1 and 200, preferably between 50 and 150. The second number can be 1 or more and, for example, between 1 and 200, preferably between 50 and 150.

According to one embodiment, the second row region is only partly overlapping or not overlapping with the first row region.

According to one embodiment, the second row region adjoins the first row region, in particular directly.

According to one embodiment, the pixel array is configured (or is controlled in such a way) to receive reception light from a first reading zone with the first row region of the pixel array and to obtain a first reception data set about the first reading zone in so doing, and to subsequently receive reception light from a second reading zone with the second row region of the pixel array and to obtain a second reception data set about the second reading zone in so doing. Preferably, the second reading zone is different from the first reading zone.

According to one embodiment, the illumination unit projects and/or focuses the transmission light onto the first reading zone for the obtaining of the first reception data set and subsequently projects and/or focuses the transmission light onto the second reading zone for the obtaining of the second reception data set. For example, the different rows of light sources can be set such that the resulting illumination highlights a respective desired one of the different reading zones and e.g. illuminates it particularly brightly. For this purpose, the light sources of a plurality of rows can be activated and can cooperate in order, for example, to illuminate exactly the and/or only the desired reading zone particularly brightly and/or homogeneously.

According to one embodiment, the processing unit is configured to combine the first and second reception data set into an extended reception data set and to use the extended reception data set. For example, an obliquely arranged barcode that is not completely present in one of the reading zones or that projects partly from each of the reading zones can still be recognized and/or read based on the combined extended reception data set. The processing unit can, for example, comprise a processor, microprocessor, FPGA, microcontroller and/or server. The processing unit can comprise a memory medium.

According to one embodiment, the second reading zone is only partly overlapping or not overlapping with the first reading zone.

According to one embodiment, the second reading zone adjoins the first reading zone, in particular directly.

According to one embodiment, the pixel array is configured (or is controlled in such a way) to receive the reception light alternately and/or in a specific order with different row regions of the pixel array. In particular, the pixel array can be configured (or can be controlled in such a way) to receive the reception light moving on the pixel array from top to bottom and/or vice versa with different row regions of the pixel array. Preferably, the pixel array is configured (or is controlled in such a way) to receive the reception light in a cyclic order with different row regions of the pixel array. In this respect, selected or all rows or row regions available in the pixel array can be used to obtain reception data about certain or all reading zones in the field of view in an application-specific manner. Depending on how quickly the active row region is changed or the position of the active reading zone is shifted, the detection speed and/or readout speed can be influenced and can thus be set in an application-specific manner.

The processing unit can be configured to recognize and/or read the barcode in the reception data about the reading zone, in particular in the first reception data set, in the second reception data set and/or in the extended reception data set. The processing unit can be configured to decode the recognized and/or read barcode. The processing unit can be configured to output an output parameter based on the recognized and/or read, in particular decoded, barcode.

A further subject of the invention is a use of an optoelectronic sensor described herein for detecting and/or reading barcodes.

A further subject of the invention is a method for detecting and/or reading barcodes, wherein light transmitted from a field of view is received as reception light by means of a pixel array and reception data about a field of view are obtained in so doing, and wherein only obtained reception data about a reading zone in the field of view are used (for detecting and/or reading the barcode), wherein the reception data about the reading zone are based on reception light received by means of a partial zone of the pixel array.

It is understood that what is described with respect to the optoelectronic sensor according to the invention also applies to the use of the optoelectronic sensor and to the method. This in particular applies to embodiments and advantages. Furthermore, it is to be understood that all the features and embodiments disclosed herein can be combined unless explicitly stated otherwise.

The invention will be described in the following purely by way of example with reference to possible embodiments and to the enclosed drawing. There are shown:

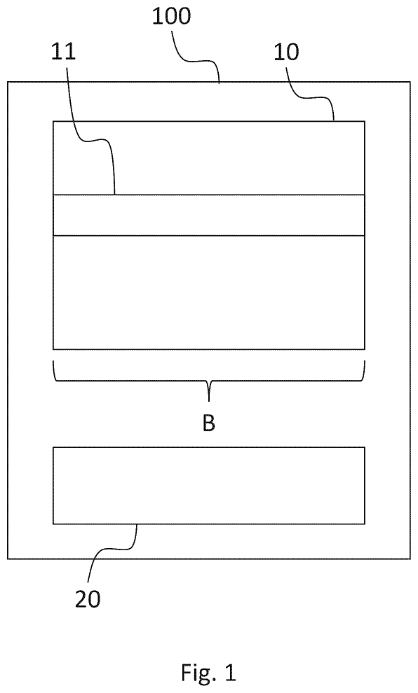

FIG. 1 a schematic representation of an optoelectronic sensor;

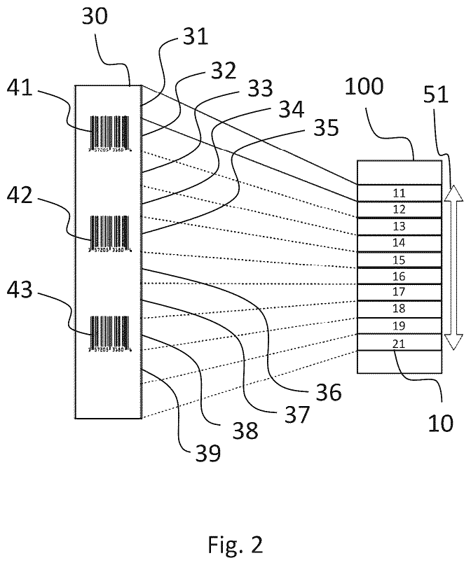

FIG. 2 a schematic representation of an optoelectronic sensor in a side view;

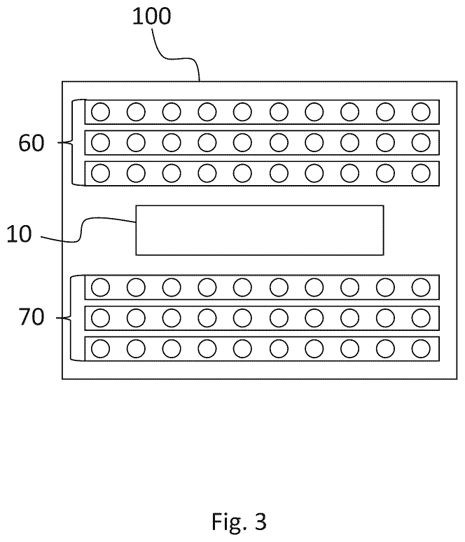

FIG. 3 a schematic representation of an optoelectronic sensor in a front view;

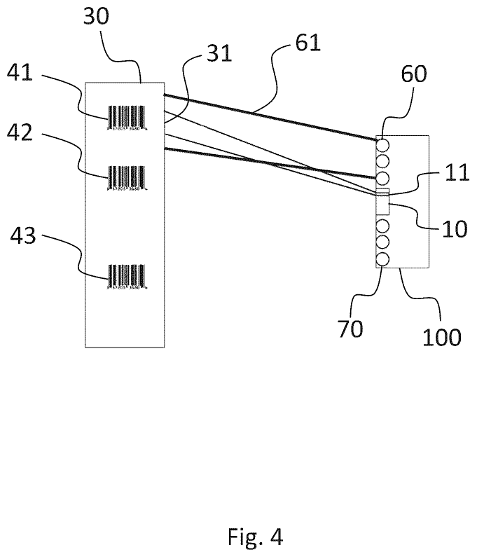

FIG. 4 a side view of the optoelectronic sensor of FIG. 3; and

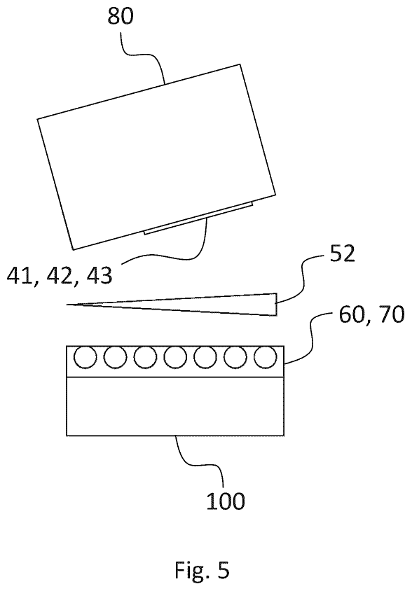

FIG. 5 a plan view of the optoelectronic sensor of FIG. 4.

The optoelectronic sensor 100 schematically shown in FIG. 1 for detecting and/or reading barcodes comprises a pixel array 10, which is configured to receive light transmitted from a field of view as reception light and to obtain reception data about the field of view in so doing, and a processing unit 20 that is configured to use only obtained reception data about a reading zone in the field of view, wherein the reception data about the reading zone are based on reception light received by means of a partial zone 11 of the pixel array 10. As shown in FIG. 1, the partial zone 11 of the pixel array 10 can correspond to a row region, wherein the rows included in the row region can be contained over their entire width B.

FIG. 2 schematically shows a side view of an optoelectronic sensor 100 for detecting and/or reading barcodes that can comprise the same or similar components as the optoelectronic sensor shown in FIG. 1. The pixel array 10 in FIG. 2 is configured to receive reception light from the field of view 30 with nine different row regions 11 to 19 of the pixel array, wherein each of the row regions can comprise a predefined number of rows, in particular rows disposed directly next to one another. For example, each of the nine row regions 11 to 19 can comprise a number of 90, 140 or 196 rows of pixels. Each of the row regions 11 to 19 can comprise the rows included in the respective row region over their entire width. As shown in FIG. 2, the row regions 11 to 19 do not overlap one another and directly adjoin one another. Alternatively, the row regions 11 to 19 can partly overlap. For example, certain rows (e.g. between 1 and 10 rows) of two row regions disposed next to one another can be used twice. Redundancy can be provided in this way. Alternatively or additionally, the pixel height of certain rows can also be different in comparison with the remaining rows. It is understood that there can also be more or fewer than nine row regions, i.e., for example, eight or ten row regions.

To detect and/or read barcodes 41, 42, 43 affixed to an object, e.g. a pallet with a plurality of packages, the pixel array 10 in FIG. 2 is configured to receive the reception light alternately and/or in a specific order, in particular moving on the pixel array 10 from top to bottom and/or vice versa (as illustrated by the arrow 51 in FIG. 2), with the different row regions 11 to 19 of the pixel array 10. Preferably, the pixel array 10 is configured to receive the reception light in a cyclic order with the different row regions 11 to 19 of the pixel array 10. In this respect, only one of the row regions 11 to 19 can always be activated and/or read for the receiving of reception light, for example. In other words, the active row region can move from a row region 11 in the upper region of the pixel array 10 downward on the pixel array 10 to a row region 19 in the lower region of the pixel 10 and back again. Selected or all rows or row regions available in the pixel array can be used for a scanning process of the field of view or a scanning sequence in order to obtain reception data in an application-specific manner about certain or all reading zones in the field of view 30. For example, only the row regions 11 to 14 can also be activated alternately and/or in a cyclic order. This can in particular be the case if, in a specific application, only the barcode 41 in the upper region of the field of view 30 is to be detected and/or read. As a further example, certain row regions, such as the row region 21 at the lower margin of the pixel array, which may not be able to sufficiently receive reception light or may not be sufficiently illuminated and may therefore be unsuitable for detecting and/or reading the barcodes, can be omitted, i.e. deactivated and/or not read.

Depending on how quickly the active row region is changed and thus the position of the active reading zone is shifted, the detection speed and/or readout speed can be influenced and can thus be set in an application-specific manner.

Until the reception of reception light with the different row regions 11 to 19, the pixel array 10 can obtain different reception data sets about the associated different reading zones 31 to 39 in the field of view 30 of the pixel array 10. As shown in FIG. 2, the reading zones 31 to 39 represent sections of the field of view 30, do not overlap with one another and directly adjoin one another. Alternatively, the reading zones 31 to 39 can partly overlap. Redundancy can be provided in this way. The processing unit (not shown in FIG. 2) can be configured to combine a plurality of the obtained reception data sets into at least one extended reception data set in a data post-processing and to use the extended reception data set. For example, the processing unit can be configured to combine the reception data sets obtained about the reading zones 31 to 33 into a first extended reception data set, to combine the reception data sets obtained about the reading zones 34 to 36 into a second extended reception data set and to combine the reception data sets obtained about the reading zones 37 to 39 into a third extended reception data set, and to use the extended reception data sets. In addition or alternatively, the processing unit (not shown in FIG. 2) can be configured to combine all the obtained reception data sets about the reading zones 31 to 39 into a total data set and to use the total data set. If the barcodes 41, 42, 43 are, for example, arranged obliquely relative to the optoelectronic sensor 100 and are thus not completely present in one of the reading zones 11 to 19, the barcodes can still be recognized and/or read using the extended reception data sets and/or using the total data set.

FIG. 3 schematically shows a front view of an optoelectronic sensor 100 for detecting and/or reading barcodes that can comprise the same or similar components as the optoelectronic sensors shown in FIG. 1 and FIG. 2. The optoelectronic sensor 100 in FIG. 3 additionally comprises an illumination unit 60, 70, which is configured to transmit transmission light into the field of view 30 (not shown in FIG. 3), wherein the pixel array 10 is configured to receive transmission light reflected from the field of view as reception light and to obtain the data about the field of view 30, in particular about the reading zones 31 to 39 in the field of view 30, in so doing. The illumination unit can comprise three rows 60 of light sources, in particular LEDs, above the pixel array 10 and three rows 70 of light sources, in particular LEDs, below the pixel array 10. In this way, the illumination of the field of view or of the reading zones in the field of view can be improved. This can in particular be advantageous if the field of view or the reading zones are dynamically detected as described herein.

FIG. 4 schematically shows a side view of the optoelectronic sensor 100 of FIG. 3. The light sources of the illumination unit 60, 70 can be individually settable in their illumination intensity. Each of the light sources can therefore be controlled such that any desired illumination intensity (as part of the power range of the respective light source) can be set. For example, as shown in FIG. 4, the illumination can be projected and/or focused onto an active illumination zone 61 by activating the light sources and/or increasing the illumination intensity of the light sources in the rows 60 of light sources above the pixel array 10. The active illumination zone 61 can comprise an active reading zone 31 in an upper region of the field of view 30, wherein the active reading zone 31 is correspondingly detected by means of an active row region 11 in the upper region of the pixel array 10. The active illumination zone 61 can be changed or shifted during the dynamic detection of the reading zones by changing the illumination intensity of the light sources. The detection and/or reading of the barcodes 41, 42, 43 in the field of view 30 can thereby be made more efficient since energy can be saved and costs can be reduced.

FIG. 5 schematically shows a plan view of the optoelectronic sensor 100 of FIG. 3 and FIG. 4. As illustrated by the ramp 52 in FIG. 5, light sources of the illumination unit 60, 70 can be controlled such that the illumination intensity of the light sources increases along a row of light sources. If the object 80 with the barcodes 41, 42, 43 is, for example, not guided in parallel with and past the optoelectronic sensor 100 or not frontally in front of the optoelectronic sensor 10, the light sources can be controlled such that regions of the barcodes 41, 42, 43 that are closer are illuminated less strongly than regions of the barcodes 41, 42, 43 that are further away.

### REFERENCE NUMERAL LIST

10 pixel array
11 row region
12 row region
13 row region
14 row region
15 row region
16 row region
17 row region
18 row region
19 row region
21 row region
20 processing unit
30 field of view
31 reading zone
32 reading zone
33 reading zone
34 reading zone
35 reading zone
36 reading zone
37 reading zone
38 reading zone
39 reading zone
41 barcode
42 barcode
43 barcode
51 arrow
52 ramp
60 rows of light sources
70 rows of light sources
80 object

1. An optoelectronic sensor for detecting and/or reading barcodes, said optoelectronic sensor comprising
a pixel array that is configured to receive light transmitted from a field of view as reception light and to obtain reception data about the field of view in so doing; and
a processing unit that is configured to use only obtained reception data about a reading zone in the field of view, wherein the reception data about the reading zone are based on reception light received by means of a partial zone of the pixel array.

2. The optoelectronic sensor according to claim 1, wherein the pixel array is configured to activate and/or read only pixels in the partial zone of the pixel array for the receiving of the reception light.

3. The optoelectronic sensor according to claim 1, further comprising an illumination unit that is configured to transmit transmission light into the field of view, wherein the pixel array is configured to receive transmission light reflected from the field of view as reception light and to obtain the reception data about the field of view in so doing.

4. The optoelectronic sensor according to claim 3, wherein the illumination unit comprises at least one row and/or column of light sources.

5. The optoelectronic sensor according to claim 4, wherein the illumination unit comprises at least two rows of light sources that are arranged above the pixel array.

6. The optoelectronic sensor according to claim 3, wherein the light sources are individually settable in their illumination intensity, wherein the light sources are controlled such that the transmission light is projected and/or focused onto the reading zone by setting the illumination intensity of the light sources.

7. The optoelectronic sensor according to claim 6, wherein the light sources are controlled such that the illumination intensity of the light sources increases along the row of light sources.

8. The optoelectronic sensor according to claim 1,
wherein the pixel array comprises columns and/or rows of pixels,
wherein the pixel array is configured to receive the reception light with a number of rows and/or a number of columns.

9. The optoelectronic sensor according to claim 8,
wherein the pixel array is configured to receive reception light with a first row region of the pixel array, wherein the first row region comprises a first number of rows, and to subsequently receive reception light with a second row region of the pixel array, wherein the second row region comprises a second number of rows, wherein the second row region is different from the first row region.

10. The optoelectronic sensor according to claim 9,
wherein the second row region is only partly overlapping or not overlapping with the first row region; and/or
wherein the second row region adjoins the first row region.

11. The optoelectronic sensor according to claim 9,
wherein the pixel array is configured to receive reception light from a first reading zone with the first row region of the pixel array and to obtain a first reception data set about the first reading zone in so doing, and to subsequently receive reception light from a second reading zone with the second row region of the pixel array and to obtain a second reception data set about the second reading zone in so doing.

12. The optoelectronic sensor according to claim 11,
wherein the second reading zone is only partly overlapping or not overlapping with the first reading zone; and/or
wherein the second reading zone adjoins the first reading zone.

13. The optoelectronic sensor according to claim 9, wherein the pixel array is configured to receive the reception light alternately and/or in a specific order, with different row regions of the pixel array.

14. A method of using the optoelectronic sensor according to claim 1 for detecting and/or reading barcodes.

15. A method for detecting and/or reading barcodes,
wherein light transmitted from a field of view is received as reception light by means of a pixel array and reception data about the field of view are obtained in so doing; and
wherein only obtained reception data about a reading zone in the field of view are used, wherein the reception data about the reading zone are based on reception light received by means of a partial zone of the pixel array.

16. The optoelectronic sensor according to claim 1, wherein the pixel array is configured to receive transmission light reflected from the field of view as reception light and to obtain the reception data about the reading zone.

17. The optoelectronic sensor according to claim 4, wherein the light sources are arranged at a marginal region of the pixel array and/or around the pixel array.

18. The optoelectronic sensor according to claim 4,
wherein the illumination unit comprises at least three rows of light sources that are arranged above the pixel array.

19. The optoelectronic sensor according to claim 4,
wherein the illumination unit comprises at least two rows of light sources that are arranged below the pixel array.

20. The optoelectronic sensor according to claim 19,
wherein the illumination unit comprises at least two three rows of light sources that are arranged below the pixel array.

21. The optoelectronic sensor according to claim 9,
wherein the first row region comprises a first number of rows disposed directly next to one another.

22. The optoelectronic sensor according to claim 9,
wherein the second row region comprises a second number of rows disposed directly adjacent to one another.

23. The optoelectronic sensor according to claim 11,
wherein the second reading zone is different from the first reading zone.

24. The optoelectronic sensor according to claim 11,
wherein the illumination unit projects and/or focuses the transmission light onto the first reading zone for the obtaining of the first reception data set and subsequently projects and/or focuses the transmission light onto the second reading zone for the obtaining of the second reception data set.

25. The optoelectronic sensor according to claim 11,
wherein the processing unit is configured to combine the first and second reception data set into an extended reception data set and to use the extended reception data set.

26. The optoelectronic sensor according to claim 13, wherein the pixel array is configured to receive the reception light alternately and/or in a specific order by moving on the pixel array from top to bottom and/or vice versa, with different row regions of the pixel array.

27. The optoelectronic sensor according to claim 26,
wherein the pixel array is configured to receive the reception light in a cyclic order with different row regions of the pixel array.
